(19) United States
(12) Patent Application Publication
(10) Pub. No.: US 2023/0234553 A1
(43) Pub. Date: Jul. 27, 2023

(54) CONTROLLER FOR VEHICLE AND CONTROL METHOD FOR VEHICLE

(71) Applicant: TOYOTA JIDOSHA KABUSHIKI KAISHA, Aichi-ken (JP)

(72) Inventors: Takeo SUZUKI, Toyota-shi (JP); Hibiki UEURA, Toyota-shi (JP)

(21) Appl. No.: 18/155,069

(22) Filed: Jan. 17, 2023

(30) Foreign Application Priority Data
Jan. 24, 2022 (JP) 2022-008717

(51) Int. Cl. B60W 20/00; B60K 6/40; B60K 6/387; B60K 6/24; B60K 6/26; F01P 5/12; F02D 41/04

(52) U.S. Cl. CPC B60W 20/00; B60K 6/40; B60K 6/387; B60K 6/24; B60K 6/26; F01P 5/12; F02D 41/042; B60Y 2200/92; B60W 2510/0676; B60W 2510/0638

(57) ABSTRACT

The vehicle includes an internal combustion engine having a crankshaft, a motor generator having an output shaft, a clutch, a water pump, a coolant temperature sensor, and a controller. The clutch is located between the crankshaft and the output shaft. The water pump is configured to pump the coolant in conjunction with rotation of the crankshaft. The coolant temperature sensor is configured to detect a coolant temperature of the internal combustion engine. The clutch is switchable between an engaged state and a disengaged state. The controller includes processing circuitry. When a predetermined condition is satisfied, the processing circuitry is capable of executing an engine stopping process of bringing the clutch into the disengaged state and stopping operation of the internal combustion engine. The predetermined condition includes that the coolant temperature detected by the coolant temperature sensor is equal to or lower than a first temperature.

### BACKGROUND

### 1. Field

The present disclosure relates to a controller for a vehicle and a control method for a vehicle.

### 2. Description of Related Art

The vehicle described in Japanese Laid-Open Patent Publication No. 2020-111276 includes an internal combustion engine, a motor generator, and a clutch. The internal combustion engine and the motor generator are drive sources of the vehicle. The internal combustion engine includes a crankshaft. The motor generator includes an output shaft. The clutch is interposed between the crankshaft of the internal combustion engine and the output shaft of the motor generator. The clutch can be switched between an engaged state and a disengaged state. When the clutch is in the engaged state, the torque of the internal combustion engine can be transmitted to the output shaft of the motor generator. When the clutch is in the disengaged state, the torque of the internal combustion engine is not transmitted to the output shaft of the motor generator.

The vehicle described in the above-mentioned publication is provided with a controller. The controller is capable of selecting an engine traveling mode, in which the vehicle travels using the internal combustion engine as a drive source, and an EV traveling mode, in which the vehicle travels using only the motor generator as a drive source. When the engine traveling mode is selected, the controller brings the clutch into the engaged state. When the EV traveling mode is selected, the controller brings the clutch into a disengaged state and stops operation of the internal combustion engine. The vehicle described in the above publication may be provided with a mechanical water pump. The water pump is coupled to the crankshaft. Therefore, the water pump is driven in conjunction with the rotation of the crankshaft. When the water pump is driven, coolant flows through the water jacket of the internal combustion engine.

When the vehicle described in the above publication is traveling in the EV traveling mode, the operation of the internal combustion engine is stopped. Accordingly, since the operation of the mechanical water pump is also stopped, the circulation of the coolant in the water jacket is also stopped. However, immediately after the operation of the internal combustion engine is stopped, the temperature of the internal combustion engine may still be high. In this case, the coolant receives heat from the internal combustion engine even though the circulation of the coolant in the water jacket is stopped. Therefore, the coolant may be overheated and boiled.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to an aspect of the present disclosure, there is provided a controller for a vehicle including: an internal combustion engine having a crankshaft; a motor generator having an output shaft that is a part of a transmission path of a driving force from the crankshaft to driven wheels; a clutch interposed between the crankshaft and the output shaft; a water pump mechanically coupled to the crankshaft and configured to pump coolant in conjunction with rotation of the crankshaft; and a coolant temperature sensor configured to detect a coolant temperature of the internal combustion engine. The clutch is switchable between an engaged state in which torque can be transmitted between the crankshaft and the output shaft and a disengaged state in which torque cannot be transmitted between the crankshaft and the output shaft. The controller is configured to execute an engine stopping process of bringing the clutch into the disengaged state and stopping the operation of the internal combustion engine when a predetermined condition is satisfied. The condition includes that the cooling coolant temperature detected by the coolant temperature sensor is equal to or lower than a first temperature defined as a temperature equal to or higher than 100° C.

Other features and aspects will be apparent from the following detailed description, the drawings, and the claims.

### BRIEF DESCRIPTION OF THE DRAWINGS

FIG. 1 is a schematic configuration diagram of a vehicle.

FIG. 2 is a flowchart of an engine control executed by a vehicle controller shown in FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

Hereinafter, an embodiment of a controller for a vehicle will be described with reference to the drawings.

<Configuration of Drive System of Vehicle>

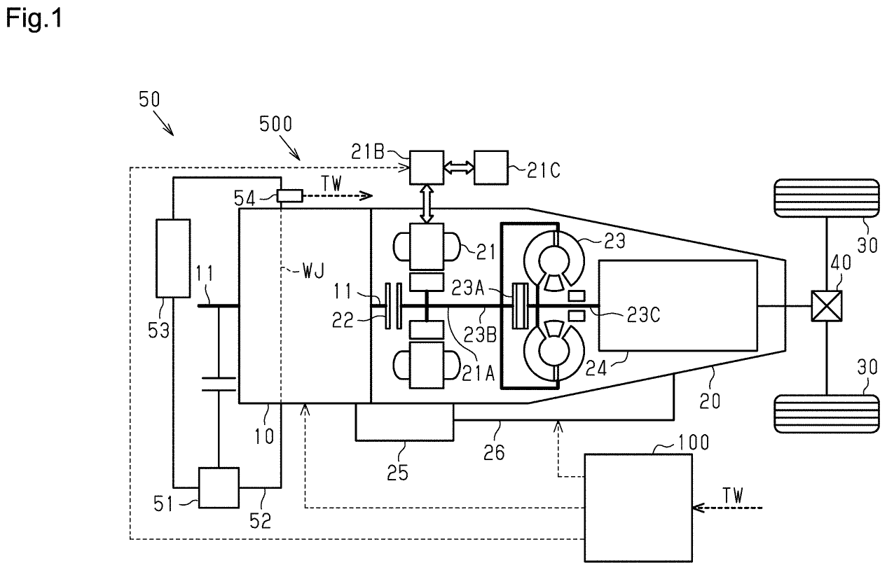

As shown in FIG. 1, a vehicle 500 includes an internal combustion engine 10, a transmission unit 20, left and right driven wheels 30, and a differential 40. The internal combustion engine 10 is a drive source for traveling. The internal combustion engine 10 has a crankshaft 11 as an output shaft.

The transmission unit 20 is located on a driving force transmission path from the internal combustion engine 10 to the driven wheels 30. The transmission unit 20 includes a motor generator 21, a clutch 22, a torque converter 23, an automatic transmission 24, a hydraulic pump 25, and a hydraulic unit 26.

The motor generator 21 is a so-called three-phase AC motor. The motor generator 21 has an output shaft 21A. The output shaft 21A is connected to the crankshaft 11 via the clutch 22. That is, the output shaft 21A is a part of the driving force transmission path from the crankshaft 11 to the driven wheels 30.

The motor generator 21 is connected to a battery 21C in the vehicle 500 via an inverter 21B in the vehicle 500. The motor generator 21 functions as an electric motor and a generator. When functioning as an electric motor, the motor generator 21 can apply torque to the crankshaft 11 with electric power from the battery 21C. When functioning as a power generator, the motor generator 21 supplies electric power to the battery 21C.

The clutch 22 is interposed between the crankshaft 11 and the output shaft 21A of the motor generator 21. The clutch 22 can be switched between an engaged state and a disengaged state by hydraulic pressure. When the clutch 22 is in the engaged state, torque can be transmitted between the crankshaft 11 and the output shaft 21A. When the clutch 22 is in the disengaged state, torque cannot be transmitted between the crankshaft 11 and the output shaft 21A.

The torque convertor 23 includes a lock-up clutch 23A, an input shaft 23B, and an output shaft 23C. The input shaft 23B is coupled to the output shaft 21A of the motor generator 21 on the side opposite to the clutch 22. The lock-up clutch 23A is interposed between the input shaft 23B and the output shaft 23C. The lock-up clutch 23A can be hydraulically switched between an engaged state and a disengaged state. When the lock-up clutch 23A is in the engaged state, the input shaft 23B and the output shaft 23C rotate integrally. When the lock-up clutch 23A is in the engaged state, the torque convertor 23 converts the torque input to the input shaft 23B and outputs the converted torque from the output shaft 23C.

The automatic transmission 24 is connected to the output shaft 23C of the torque convertor 23. That is, the automatic transmission 24 is coupled to the crankshaft 11 via the torque converter 23. Although not shown, the automatic transmission 24 includes a plurality of gear mechanisms and a plurality of engagement elements. The engagement elements of the automatic transmission 24 are, for example, a clutch mechanism and a brake mechanism. Each engagement element of the automatic transmission 24 can be switched between an engaged state and a disengaged state by hydraulic pressure. By switching between the engaged state and the disengaged state of each of the engagement elements, the automatic transmission 24 can switch the gear position.

The hydraulic pump 25 is an electric pump. The hydraulic pressure generated by the hydraulic pump 25 is supplied to the transmission unit 20. In particular, the hydraulic pressure generated by the hydraulic pump 25 is supplied to the clutch 22, the torque convertor 23, the lock-up clutch 23A, and the automatic transmission 24.

The hydraulic unit 26 includes hydraulic circuits for the clutches 22, the torque converters 23, the lock-up clutch 23A, and the automatic transmissions 24, and various hydraulic control valves for controlling hydraulic pressures of the hydraulic circuits. By controlling the hydraulic unit 26, for example, the engaged state and the disengaged state of the clutch 22 are switched. In FIG. 1, the hydraulic circuits and the hydraulic control valves of the hydraulic unit 26 are not shown.

The differential 40 is coupled to the automatic transmission 24 and the drive wheels 30. That is, the differential 40 is interposed between the transmission unit 20 and the drive wheels 30. The differential 40 distributes the torque output from the transmission unit 20 to the left and right driven wheels 30. The differential 40 allows a difference in rotational speed to occur between the left and right drive wheels 30.

<Cooling Structure of Internal Combustion Engine>

The vehicle 500 has a cooling structure 50 for the internal combustion engine 10. The cooling structure 50 includes a water pump 51, a cooling passage 52, a radiator 53, and a coolant temperature sensor 54.

The water pump 51 is mechanically coupled to the crankshaft 11 of the internal combustion engine 10 via gears. Therefore, the water pump 51 discharges the coolant in conjunction with rotation of the crankshaft 11. A discharge port of the water pump 51 is connected to an upstream end of the cooling passage 52. Therefore, the water pump 51 pumps the coolant to the cooling passage 52. A downstream end of the cooling passage 52 is connected to a suction port of the water pump 51. That is, the coolant discharged from the water pump 51 flows back to the water pump 51.

A part of the cooling passage 52 is a water jacket WJ of the internal combustion engine 10. The water jacket WJ is a space defined inside a cylinder block, a cylinder head, and the like in the internal combustion engine 10.

The radiator 53 is located on the downstream side of the cooling passage 52 when viewed from the water jacket WJ. The radiator 53 is a heat exchanger that cools the coolant heated to a high temperature by causing the coolant to flow through the water jacket WJ and the like of the internal combustion engine 10.

The coolant temperature sensor 54 is located in the middle of the cooling passage 52. Specifically, the coolant temperature sensor 54 is located near the outlet of the water jacket WJ. The coolant temperature sensor 54 detects the coolant temperature TW of the coolant passing through the cooling passage 52. That is, in the present embodiment, the coolant temperature sensor 54 detects the coolant temperature TW of the internal combustion engine 10.

The cooling structure 50 includes a branch passage that branches off from the cooling passage 52 and is connected to the cooling passage 52 again via another object to be cooled, a valve for adjusting the amount of coolant flowing through the branch passage, and the like. In FIG. 1, the structure related to the water jacket WJ and the radiator 53 is schematically illustrated while omitting illustration of a branch passage, a valve, and the like.

<Controller>

The vehicle 500 includes the controller 100. The controller 100 may be processing circuitry including: 1) one or more processors that operate according to a computer program (software); 2) one or more dedicated hardware circuits (application specific integrated circuits: ASIC) that execute at least part of various processes, or 3) a combination thereof. The processor includes a central processing unit (CPU) and memories such as a random-access memory (RAM) and a read-only memory (ROM). The memories store program codes or commands configured to cause the CPU to execute processes. The memory, which is a computer-readable medium, includes any type of media that are accessible by general-purpose computers and dedicated computers. The controller 100 receives a signal related to the coolant temperature TW detected by the coolant temperature sensor 54.

The controller 100 controls the internal combustion engine 10. The controller 100 controls execution and stopping of combustion in the internal combustion engine 10. That is, the controller 100 is capable of changing the internal combustion engine 10 between an operating state and a stopped state.

The controller 100 is capable of selecting an HV traveling mode, in which the vehicle travels using the internal combustion engine 10 as a drive source, and an EV traveling mode, in which the vehicle travels using only the motor generator 21 as a drive source. When the HV traveling mode is selected, the controller 100 brings the clutch 22 into the engaged state. When the EV traveling mode is selected, the controller 100 brings the clutch 22 into the disengaged state and stops the operation of the internal combustion engine 10. The controller 100 selects one of the HV traveling mode and the EV traveling mode based on the required power of the vehicle 500, the charging amount of the battery 21C, and the like.

The controller 100 controls the hydraulic unit 26. As described above, the controller 100 switches the clutch 22 between the engaged state and the disengaged state by controlling the hydraulic unit 26. Further, the controller 100 is capable of switching the gear position of the automatic transmission 24 by controlling the hydraulic unit 26.

The controller 100 is capable of executing the engine stopping process when a predetermined condition is satisfied. In the engine stopping process, the controller 100 brings the clutch 22 into the disengaged state. Further, the controller 100 stops the operation of the internal combustion engine 10 in the engine stopping process. The predetermined condition for executing the engine stopping process includes a condition that there is a request to change the traveling mode from the HV traveling mode to the EV traveling mode and that the coolant temperature TW detected by the coolant temperature sensor 54 is equal to or lower than a first temperature T1. The first temperature T1 is determined in advance as a temperature equal to or higher than 100 degrees. In the present embodiment, the first temperature T1 is 107 degrees.

The controller 100 is configured to execute a coolant circulation process if the coolant temperature TW detected by the coolant temperature sensor 54 when the predetermined condition for executing the engine stopping process is satisfied is equal to or higher than a second temperature T2. The controller 100 brings the clutch 22 into the disengaged state in the coolant circulation process. Further, the controller 100 drives the internal combustion engine 10 in the coolant circulation process. That is, in the coolant circulation process, the water pump 51 is driven in a state where the torque of the internal combustion engine 10 is not transmitted to the drive wheels 30. The controller 100 executes the above-described engine stopping process after executing the coolant circulation process.

The second temperature T2 is determined in advance as a temperature lower than the first temperature T1. The second temperature T2 is determined such that the difference between the second temperature T2 and the first temperature T1 is 5 degrees or less. In the present embodiment, the second temperature T2 is 105 degrees. During execution of the coolant circulation process, the controller 100 maintains the engine speed of the internal combustion engine 10 at a minimum idle speed at which the internal combustion engine 10 can continue to drive independently. An example of the idle speed is several hundred rpm to one thousand and several hundred rpm.

<Engine Control Executed by Controller>

The engine control executed by the controller 100 will be described below. The controller 100 repeatedly executes the engine control while the HV traveling mode is selected.

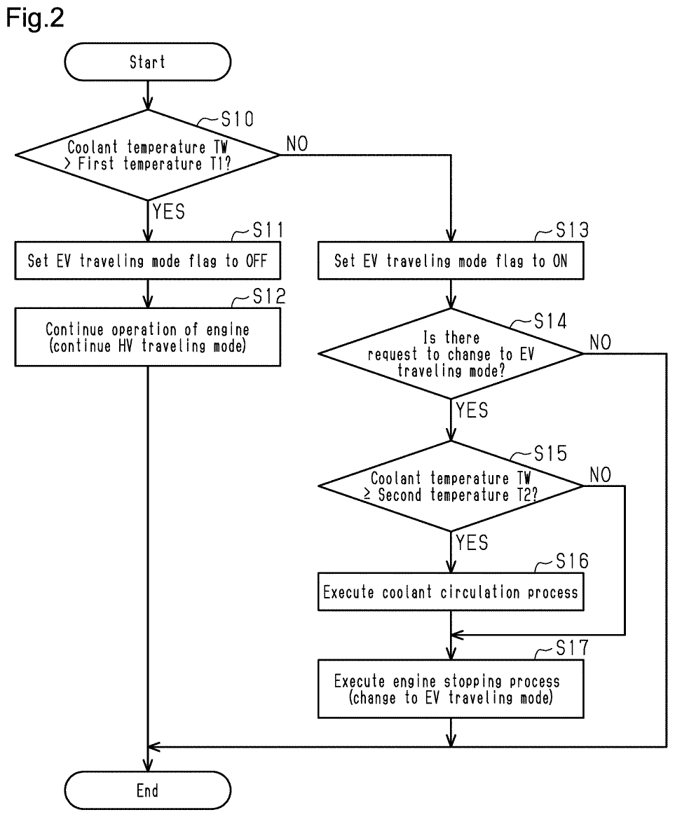

As shown in FIG. 2, when executing the engine control, the controller 100 first executes the process of step S10. In step S10, the controller 100 acquires the coolant temperature TW detected by the coolant temperature sensor 54. The controller 100 determines whether the coolant temperature TW is higher than the first temperature T1. When the coolant temperature TW is higher than the first temperature T1 (S10: YES), the process of the controller 100 proceeds to step S11.

In step S11, the controller 100 sets the EV traveling mode flag to OFF. The EV traveling mode flag is a flag indicating whether a change from the HV traveling mode to the EV traveling mode is permitted or prohibited. When the EV traveling mode flag is ON, a change to the EV traveling mode is permitted. When the EV traveling mode flag is OFF, a change to the EV traveling mode is prohibited. After step S11, the process of the controller 100 proceeds to step S12.

In step S12, controller 100 continues the HV traveling mode regardless of whether or not there is a request to change the traveling mode to the EV traveling mode. That is, the controller 100 maintains the engagement state of the clutch 22 and continues the operation of the internal combustion engine 10. Thereafter, the controller 100 ends the engine control.

When the coolant temperature TW is equal to or lower than the first temperature T1 (S10: NO), the process of the controller 100 proceeds to step S13. In step S13, the controller 100 sets the EV traveling mode flag to ON in order to permit the change from the HV traveling mode to the EV traveling mode. Thereafter, the process of the controller 100 proceeds to step S14.

In step S14, the controller 100 determines whether there is a request to change the traveling mode to the EV traveling mode. When there is no request to change the traveling mode to the EV traveling mode (S14: NO), the controller 100 ends the engine control. When there is a request to change the traveling mode to the EV traveling mode (S14: YES), the process of the controller 100 proceeds to step S15.

In step S15, controller 100 determines whether the coolant temperature TW acquired in step S10 is equal to or higher than the second temperature T2. When the coolant temperature TW is equal to or higher than the second temperature T2 (S15: YES), the process of the controller 100 proceeds to step S16.

In step S16, the controller 100 executes the coolant circulation process. As described above, in the coolant circulation process, the controller 100 brings the clutch 22 into the disengaged state and drives the internal combustion engine 10. That is, the controller 100 drives the water pump 51. In addition, the controller 100 maintains the engine speed of the internal combustion engine 10 at the idle speed during the coolant circulation process.

The controller 100 calculates the execution time of the coolant circulation process based on a map. The map is stored in the controller 100 in advance. The map is set such that the higher the coolant temperature TW detected by the coolant temperature sensor 54 is, the longer the time for which the coolant circulation process is executed becomes. For example, when the coolant temperature TW is 105 degrees, the controller 100 executes the coolant circulation process for 2 seconds. For example, when the coolant temperature TW is 107 degrees, the controller 100 executes the coolant circulation process for 10 seconds. The controller 100 applies the coolant temperature TW acquired in step S10 to the map to determine the execution time of the coolant circulation process. Thereafter, the process of the controller 100 proceeds to step S17.

When a negative determination is made in step S15 (S15: NO), the process of the controller 100 directly proceeds to step S17 without going through the process of step S16. In step S17, the controller 100 executes an engine stopping process. When step S17 is reached through step S16, the clutch 22 is already in the disengaged state at the time of proceeding to step S17. Therefore, in this case, the controller 100 maintains the clutch 22 in the disengaged state and stops the operation of the internal combustion engine 10 in the engine stopping process. If step S17 is reached without going through step S16, the controller 100 brings the clutch 22 into the disengaged state and stops the operation of the engine 10. After execution of the engine stopping process, the controller 100 ends the engine control.

### Operation of Present Embodiment

When the vehicle 500 is traveling in the HV traveling mode, the temperature of the internal combustion engine 10 increases. If the operation of the internal combustion engine 10 is stopped in a state in which the temperature of the internal combustion engine 10 is high, the temperature of the internal combustion engine 10 immediately thereafter may still be high. When the operation of the internal combustion engine 10 is stopped and the traveling mode is changed to the EV traveling mode, the crankshaft 11 does not rotate. Accordingly, the water pump 51 is stopped, and the circulation of the coolant in the water jacket WJ is also stopped. In this case, the coolant receives heat from the internal combustion engine 10 even though the circulation of the coolant in the water jacket WJ is stopped. As a result, the coolant may be overheated and boiled. In particular, the water jacket WJ has a narrow coolant passage having a diameter of about several millimeters, which is called a drill path. The coolant present in such a drill path has a large area of contact with the wall of the internal combustion engine 10 for its volume. That is, since the amount of heat received for the volume of the coolant is large, the coolant may boil.

In the present embodiment, in the engine control, when the coolant temperature TW is higher than the first temperature T1, the controller 100 continues to drive the engine 10. That is, the controller 100 continues to drive the water pump 51.

In contrast, when the coolant temperature TW is equal to or lower than the first temperature T1, the controller 100 sets the EV traveling mode flag to ON. That is, the controller 100 sets a state in which execution of the engine stopping process is permitted.

When the coolant temperature TW is equal to or lower than the first temperature T1 and equal to or higher than the second temperature T2, the controller 100 first executes the coolant circulation process. Then, the controller 100 executes the engine stopping process.

### Advantages of Present Embodiment

(1) In the above-described embodiment, the controller 100 sets the EV traveling mode flag to ON on condition that at least the coolant temperature TW of the engine 10 is equal to or lower than the first temperature T1. When there is a request to change the EV traveling mode while the EV traveling mode flag is ON, the controller 100 executes the engine stopping process. Therefore, even if the operation of the water pump 51 is stopped along with the engine stopping process, there is a low possibility that the coolant in the water jacket WJ of the internal combustion engine 10 will boil. In particular, boiling can be effectively prevented in the coolant inside the above-described drill path or the like.

(2) In the above-described embodiment, when there is an EV traveling mode change request, the controller 100 executes the coolant circulation process on condition that the coolant temperature TW is equal to or lower than the first temperature T1 and equal to or higher than the second temperature T2. After executing the coolant circulation process, the controller 100 executes the engine stopping process.

As described above, even if the coolant temperature TW is equal to or lower than the first temperature T1, when the coolant temperature TW is a considerably high temperature equal to or higher than the second temperature T2, the water pump 51 is also driven in accordance with the operation of the engine 10. Therefore, the coolant in the water jacket WJ of the internal combustion engine 10 flows, and the cooled coolant is newly supplied into the water jacket WJ. Therefore, even if the engine stopping process is executed thereafter, there is a low possibility that the coolant in the water jacket WJ of the internal combustion engine 10 will boil.

(3) In the above embodiment, the controller 100 executes the coolant circulation process for a longer period of time as the coolant temperature TW acquired in step S10 increases. According to this configuration, as the coolant temperature TW at the time when the condition of the engine stopping process is satisfied increases, a larger amount of coolant flows in the coolant circulation process. Therefore, before the engine stopping process is executed, the coolant in the water jacket WJ of the internal combustion engine 10 and the internal combustion engine 10 is cooled effectively.

(4) In the above-described embodiment, the controller 100 maintains the engine speed of the internal combustion engine 10 during the coolant circulation process at the minimum idle speed, at which the internal combustion engine 10 can continue to drive independently. According to this configuration, it is possible to minimize the engine speed of the internal combustion engine 10 during the coolant circulation process that does not contribute to the torque of the drive wheels 30. Therefore, it is possible to minimize the deterioration of the fuel efficiency due to the coolant circulation process.

(5) In the above embodiment, the difference between the first temperature T1 and the second temperature T2 is 5 degrees or less. According to this configuration, the coolant circulation process that may cause deterioration in fuel efficiency is executed only when the coolant temperature TW is a considerably high temperature close to the first temperature T1. That is, the controller 100 can execute the coolant circulation process only when the necessity of the coolant circulation process is high.

<Modifications>

The above-described embodiment may be modified as follows. The above-described embodiment and the following modifications can be combined with each other as long as there is no technical contradiction.

The overall configuration of the vehicle 500 is not limited to the example of the above embodiment. The vehicle 500 may include at least the internal combustion engine 10, the motor generator 21, the clutch 22, the water pump 51, and the coolant temperature sensor 54.

In step S15 of the engine control, the controller 100 may acquire the coolant temperature TW from the coolant temperature sensor 54 again. That is, the controller 100 may use the coolant temperature TW acquired in step S15 for the determination in step S15.

In the engine control, the controller 100 may omit the process of step S15 and step S16. That is, when it is determined that the coolant temperature TW is equal to or lower than the first temperature T1, the controller 100 may execute the engine stopping process regardless of the value of the coolant temperature TW.

The controller 100 may uniformly set the execution time of the coolant circulation process to the same time regardless of the coolant temperature TW. In this case, in the above-described embodiment, the controller 100 omits the calculation of the execution time of the coolant circulation process in step S16.

The controller 100 may end the coolant circulation process when the coolant temperature TW becomes equal to or lower than a predetermined threshold value. The threshold value may be set to, for example, an upper limit value of a temperature at which the coolant is not likely to boil even if the water pump 51 is stopped. According to this configuration, the controller 100 can execute the coolant circulation process until the coolant temperature TW becomes sufficiently low.

The engine speed during the coolant circulation process is not limited to the example of the above embodiment. That is, it may be higher than the idle speed. The engine speed during the coolant circulation process may be any speed as long as the water pump 51 can be driven at that speed.

The difference between the first temperature T1 and the second temperature T2 may be greater than 5 degrees. In the above-described embodiment, the values of the first temperature T1 and the second temperature T2 are not limited to the examples of the above-described embodiment. However, the difference between the first temperature T1 and the second temperature T2 is preferably equal to or less than 5 degrees in order to avoid excessively frequent execution of the coolant circulation process.

The condition for starting the execution of the engine control by the controller 100 may include the presence of a request for changing the HV traveling mode to the EV traveling mode. In this case, the controller 100 can omit the process of step S11, step S13, and step S14 of the engine control in the above embodiment.

The execution condition of the engine stopping process may include at least a condition that the coolant temperature TW detected by the coolant temperature sensor 54 is equal to or lower than the first temperature T1. That is, in the above embodiment, another condition may be included in the execution condition of the engine stopping process.

The engine stopping process may be executed at a time other than when the traveling mode is changed to the EV traveling mode. For example, if the controller 100 brings the clutch 22 into the disengaged state and stops the operation of the internal combustion engine 10 when stopping the vehicle 500, the controller 100 may execute the engine stopping process when stopping the vehicle 500.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A controller for a vehicle, wherein
the vehicle includes:
an internal combustion engine having a crankshaft;
a motor generator having an output shaft that is a part of a transmission path of a driving force from the crankshaft to a driven wheel;
a clutch interposed between the crankshaft and the output shaft;
a water pump mechanically coupled to the crankshaft and configured to pump coolant in conjunction with rotation of the crankshaft; and
a coolant temperature sensor configured to detect a coolant temperature of the internal combustion engine,
the clutch is configured to be switched between an engaged state in which torque can be transmitted between the crankshaft and the output shaft and a disengaged state in which torque cannot be transmitted between the crankshaft and the output shaft,
the controller includes processing circuitry,
the processing circuitry is configured to execute an engine stopping process of bringing the clutch into the disengaged state and stopping operation of the internal combustion engine when a predetermined condition is satisfied, and
the predetermined condition includes a condition that the coolant temperature detected by the coolant temperature sensor is equal to or lower than a first temperature defined as a temperature equal to or higher than 100 degrees.

2. The controller according to claim 1, wherein, when the predetermined condition is satisfied and the coolant temperature detected by the coolant temperature sensor is equal to or higher than a second temperature defined as a temperature lower than the first temperature, the processing circuitry is configured to execute the engine stopping process after executing a coolant circulation process that is a process of driving the internal combustion engine with the clutch in the disengaged state.

3. The controller according to claim 2, wherein the processing circuitry is configured to execute the coolant circulation process for a longer period of time as the coolant temperature detected by the coolant temperature sensor when the predetermined condition is satisfied increases.

4. The controller according to claim 2, wherein the processing circuitry is configured to maintain, during the coolant circulation process, an engine speed of the internal combustion engine at a minimum idle speed at which the internal combustion engine can continue to drive independently.

5. The controller according to claim 2, wherein a difference between the first temperature and the second temperature is 5 degrees or less.

6. A control method for a vehicle, wherein
the vehicle includes:
an internal combustion engine having a crankshaft;
a motor generator having an output shaft that is a part of a transmission path of a driving force from the crankshaft to a driven wheel;
a clutch interposed between the crankshaft and the output shaft; and
a water pump mechanically coupled to the crankshaft,
the control method comprises:
pumping, by the water pump, coolant in conjunction with rotation of the crankshaft;
detecting a coolant temperature of the internal combustion engine;
switching the clutch between an engaged state in which torque can be transmitted between the crankshaft and the output shaft and a disengaged state in which torque cannot be transmitted between the crankshaft and the output shaft;
bringing the clutch into the disengaged state and stopping operation of the internal combustion engine when a predetermined condition is satisfied, and
the predetermined condition includes a condition that the coolant temperature detected by the coolant temperature sensor is equal to or lower than a first temperature defined as a temperature equal to or higher than 100 degrees.
